(19) United States
(12) Patent Application Publication
(10) Pub. No.: US 2007/0294559 A1
(43) Pub. Date: Dec. 20, 2007

(54) Method and Device for Delaying Access to Data and/or Instructions of a Multiprocessor System

(76) Inventor: Thomas Kottke, Ehningen (DE)

Correspondence Address: KENYON & KENYON LLP, ONE BROADWAY, NEW YORK, NY, 10004, US

(21) Appl. No.: 11/666,328

(22) PCT Filed: Oct. 25, 2005
(86) PCT No.: PCT/EP05/55542

§ 371 Date: Apr. 24, 2007

(30) Foreign Application Priority Data
Oct. 25, 2004 (DE) 10 2004 051 852.8
Oct. 25, 2004 (DE) 10 2004 051 964.1
Oct. 25, 2004 (DE) 10 2004 051 937.4
Oct. 25, 2004 (DE) 10 2004 051 992.7

(51) Int. Cl. G06F 1/04

(52) U.S. Cl. 713/601

(57) ABSTRACT

A method and a device for delaying the accesses to data and/or instructions of a multiprocessor system having a first and a second processor, with which a memory unit is associated, wherein the second processor operates with a clock pulse offset, and the device is arranged so that the first processor accesses the memory unit and the second processor receives the data and/or instructions with a clock pulse offset.

### FIELD OF THE INVENTION

The present invention is directed to a method for delaying access to data and/or instructions of a multiprocessor system and a corresponding delay unit.

### BACKGROUND INFORMATION

In technical applications such as in the automobile industry or in the industrial goods industry in particular, i.e., in mechanical engineering and automation, more and more microprocessor-based or computer-based control and regulating systems are being used for applications critical with regard to safety. Dual computer systems or dual processor (dual core) systems are nowadays widely used computer systems for applications critical with regard to safety in particular in vehicles, such as antilock systems, electronic stability programs (ESP), X-by-wire systems such as drive-by-wire or steer-by-wire or brake-by-wire, etc. or also in other networked systems. To satisfy these high safety requirements in future applications, powerful error mechanisms and error handling mechanisms are needed, in particular to counteract transient errors arising, for example, when the size of semiconductor structures of computer systems is reduced. It is relatively difficult to protect the core itself, i.e., the processor. One approach, as mentioned above, is the use of a dual-core system for error detection.

Such processor units having at least two integrated processing units are known as dual core or multicore architectures. Such dual core or multicore architectures are currently proposed mainly for two reasons:

First, they may contribute to an enhanced performance in that the two processing units or cores are considered and treated as two arithmetic units on a single semiconductor module. In this configuration, the two processing units or cores process different programs or tasks. This allows enhanced performance; for this reason, this configuration is referred to as performance mode.

The second reason for implementing a dual-core or multicore architecture is enhanced reliability in that the two processing units redundantly process the same program. The results of the two processing units or CPUs, i.e., cores, are compared, and an error may be detected from the comparison for agreement. In the following, this configuration is referred to as safety mode or error detection mode.

Thus, currently there are both dual processor and multiprocessor systems that work redundantly to recognize hardware errors (see dual core or master checker systems), and dual processor and multiprocessor systems that process different data on their processors.

### SUMMARY OF THE INVENTION

If these two operating modes are combined according to one embodiment of the present invention in a dual processor or multiprocessor system (for the sake of simplicity we shall only refer to dual processor systems; however, the present invention is also applicable to multiprocessor systems), both processors must contain different data in performance mode and the same data in error detection mode.

Such a device or unit makes it possible to operate a dual processor system effectively in such a way that switchover during operation is possible in both safety and performance modes. We shall therefore refer to processors, which, however, also includes the concept of cores or arithmetic units.

When dual-processor (dual-core) systems are implemented in particular, a cache is usually provided for each processor. One cache is usually not sufficient, since this cache must be spatially situated between the two processors. Due to the long propagation time between the cache and the two processors, the two processors could only operate with a limited clock frequency. In the system, the caches are used as fast buffer memories, so that the processor does not always have to retrieve data from the slow main memory. To make this possible, the access speed of the cache must be kept in mind when implementing a cache. The access speed is composed of the actual access speed for retrieving the data from the cache and the time for relaying the data to the processor. If the cache is spatially far removed from the processor, the transmission of data takes a long time and the processor is unable to operate at its full clock frequency. Therefore, in the case of dual-processor systems, a cache is usually provided for each processor.

An object of the present invention is to provide a method and a device which allows one cache to be omitted in a dual processor system or the redundant caches to be omitted in multiprocessor systems. The savings are achieved by making use of a clock pulse offset.

The present invention describes, as an approach for achieving the object of the invention, a method and a device for delaying access to data and/or instructions of a multiprocessor system having a first and a second processor, with which a memory unit is associated, the second processor operating at a clock pulse offset and the device being designed in such a way that the first processor accesses the memory unit and the second processor receives the data and/or instructions with a clock pulse offset. The memory unit is advantageously a cache memory, which allows the advantages of this memory technology to be combined with the advantages of the present invention.

The memory unit is advantageously addressed by at least one processor and is directly connected to the processor which addresses it.

It is advantageous that a delay element is provided and the device is designed in such a way that the clock pulse offset is used by the delay element for bridging the propagation time of the data and/or instructions from the memory unit to the second processor.

It is furthermore advantageous that a comparison arrangement is provided, using which the data and/or instructions are compared and the comparison arrangement is situated in the spatial proximity of the processor that follows.

The device is advantageously designed in such a way that the clock pulse offset is used for relaying the comparison data between the first processor and the second processor.

It is advantageous that, depending on the configuration, either write and read operations or only read operations or only write operations are delayed as accesses.

If these two processors are operated with a clock pulse offset, the second cache for the slave processor may be omitted using the proposed method and the corresponding device.

### BRIEF DESCRIPTION OF THE DRAWINGS

FIG. 1 shows a dual-core system having a first computer 100, in particular a master computer and a second computer 101, in particular a slave computer.

FIG. 2 concerns an exemplary implementation of the data distribution unit (DDU) which may be composed of a device for detecting the switchover intent (via IIIOPDetect), the mode switch unit, and the iram and dram control module.

FIG. 3 shows the clock pulse switchover using an example, so that a clock pulse switchover takes place from one mode into another mode.

FIG. 4 schematically depicts, in the implementations of dual-core systems in particular, a cache for each processor.

FIG. 5 shows an exemplary method so that when these two processors are operated at a clock pulse offset, the second cache for the slave processor is no longer needed by using the method.

FIG. 6 shows, in the case of an exemplary clock pulse offset of 1.5 clock pulses, that two flip-flops may be used in the context of the exemplary embodiment and/or exemplary method of the present invention.

### DETAILED DESCRIPTION

This dual-core system has two processors which may process the same tasks or different tasks. These two processors of the dual-core system may process these tasks synchronously or with a clock pulse offset. If a dual processor system is designed for error detection, it is advantageous that these two processors operate at a clock pulse offset to avoid common-mode errors. This method is most effective if a non-integer clock pulse offset >1 is selected. In other words, in this first application both processors or cores process the same tasks.

If the two processors are processing different tasks, it is more advantageous to have them run with synchronized clock pulse edges, since the external components such as memories may be controlled using the clock pulse of only one processor. For example, if a dual processor system which is switchable between these two modes is used, it is therefore optimized for one operating mode.

This is compensated according to the present invention in a dual processor or multiprocessor system which is switchable between two modes such as safety and performance by having the two processors operate with a clock pulse offset in the safety mode and without a clock pulse offset in the performance mode. In the performance mode, using no clock pulse offset is advantageous, because the external components such as memories are usually operated at a lower clock frequency and are laid out to fit only a single processor with respect to the clock pulse edge. Otherwise the second processor having a clock pulse offset would have a waiting clock pulse at the time of each memory access, since it activates the external component one-half clock pulse too late.

In a dual-processor system, optimum error detection is achieved in the safety mode and maximum performance is achieved in the performance mode via clock switchover.

Thus, the present invention is directed to a method and a device for delaying access to data and/or instructions of a multiprocessor system having a first and a second processor, with which a memory unit is associated, the first and second processors operating at a clock pulse offset and the device being designed in such a way that both processors access the same memory unit with this clock pulse offset.

Write operations and read operations as accesses are advantageously delayed, the device being switchable between delayed accesses and non-delayed accesses. A multiprocessor system having such a device is furthermore disclosed.

In at least one mode, the two processors operate at a clock pulse offset. This may be offset by an entire clock pulse or by a partial clock pulse with respect to one another. In another variant, a different clock frequency is used in the two modes. In the mode that is critical with regard to safety, a lower clock frequency may be used than in the performance mode, for example, to suppress interference. These two variants may also be combined with one another.

The first operating mode corresponds to a safety mode in which the two computer units process the same programs and/or data, and the comparison arrangement is provided, which compare the states resulting from the processing of the same programs for agreement.

The unit according to the present invention and the method according to the present invention make optimized implementation of both modes possible in a dual-processor system.

If the two processors operate in the error detection mode (F mode), the two processors receive the same data/instructions; if they operate in the performance mode (P mode), each processor may access the memory. In that case, this unit manages the accesses to the single memory or peripheral present.

In the F mode, the unit receives the data/addresses of a processor (here referred to as “master”) and relays them to the components such as memories, bus, etc. The second processor (here “slave”) wishes to access the same device. The data distribution unit receives this request at a second port, but does not relay it to the other components. The data distribution unit transmits the same data to both slave and master and compares the data of the two processors. If they are different, the data distribution unit (here DDU) shows this via an error signal. Therefore, only the master operates as to the bus/memory and the slave receives the same data (mode of operation as in the case of a dual-core system).

In the P mode both processors process different program portions. The memory accesses are therefore also different. The DDU therefore receives the request of the processors and returns the results/requested data to the processor that requested them. If both processors wish to access the same component at the same time, one processor is set to a wait state until the other one has been served.

Switchover between the two modes and thus between the different types of operation of the data distribution unit takes place via a control signal, which may be generated by one of the two processors or externally.

If the dual-processor system is operated with a clock pulse offset in the F mode, but not in the P mode, the DDU delays the data for the slave as needed, i.e., stores the master's output data until it may be compared to the slave's output data for error detection.

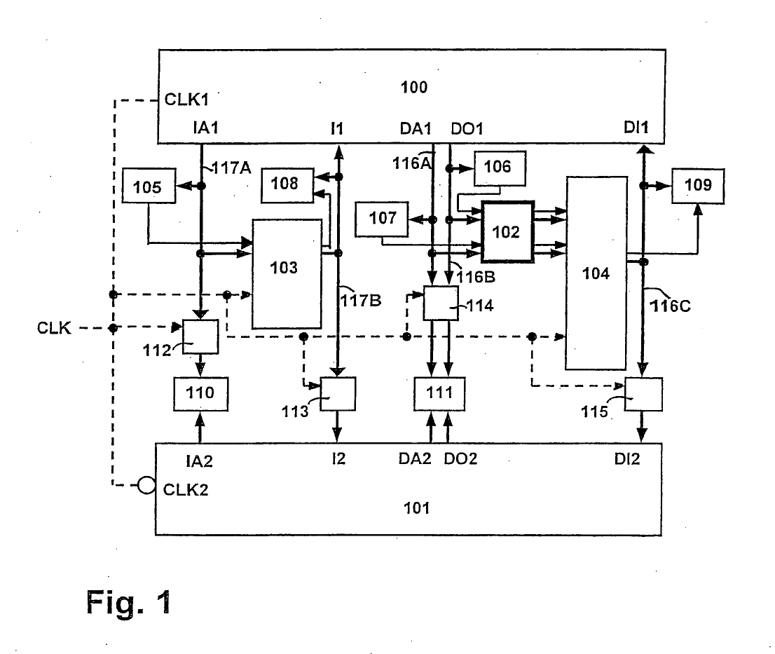

The clock pulse offset is elucidated in more detail for a dual-core system with reference to FIG. 1.

FIG. 1 shows a dual-core system having a first computer 100, in particular a master computer and a second computer 101, in particular a slave computer. The entire system is operated at a predefinable clock pulse, i.e., in predefinable clock cycles CLK. The clock pulse is supplied to the computers via clock input CLK1 of computer 100 and clock input CLK2 of computer 101. In this dual-core system, there is also a special feature for error detection in that first computer 100 and second computer 101 operate at a predefinable time offset or a predefinable clock pulse offset. Any desired time period may be defined for a time offset, and also any desired clock pulse regarding an offset of the clock pulses. This may be an offset by an integral number of clock pulses, but also, as shown in this example, an offset by 1.5 clock pulses, first computer 100 working, i.e., being operated here 1.5 clock pulses ahead of second computer 101. This offset may prevent common mode failures from interfering with the computers or processors, i.e., the cores of the dual-core system, in the same way and thus from remaining undetected. In other words, due to the offset, such common mode failures affect the computers at different points in time during the program run and thus have different effects for the two computers, which makes errors detectable. Under certain circumstances, effects of errors of the same type would not be detectable in a comparison without a clock pulse offset; this is avoided by the method according to the present invention. To implement this time or clock pulse offset, 1.5 clock pulses in this particular case of a dual-core system, offset modules 112 through 115 are provided.

To detect the above-mentioned common mode errors, this system is designed to operate at a predefined time offset or clock pulse offset, here 1.5 clock pulses, i.e., while one of the computers, e.g., computer 100, is addressing external components 103 and 104 directly in particular, second computer 101 is running with a delay of exactly 1.5 clock pulses. To generate the desired 1.5-clock pulse delay in this case, computer 101 is supplied with the inverted clock (signal) at clock input CLK2. However, the above-mentioned terminals of the computer, i.e., its data and/or instructions, must therefore also be delayed by the above-mentioned clock pulses, here 1.5 clock pulses in particular; as mentioned previously offset or delay modules 112 through 115 are provided for this purpose. In addition to the two computers or processors 100 and 101, components 103 and 104 are provided, which are connected to the two computers 100 and 101 via bus 116, having bus lines 116A, 116B, and 116C, and bus 117, having bus lines 117A and 117B. Bus 117 is an instruction bus, 117A being an instruction address bus and 117B being the partial instruction (data) bus. Address bus 117A is connected to computer 100 via an instruction address terminal IA1 (instruction address 1) and to computer 101 via an instruction address terminal IA2 (instruction address 2). The instructions proper are transmitted via partial instruction bus 117B, which is connected to computer 100 via an instruction terminal I1 (instruction 1) and to computer 101 via an instruction terminal I2 (instruction 2). In this instruction bus 117 having 117A and 117B, one component 103, an instruction memory, for example, a safe instruction memory in particular or the like is connected in between. This component, in particular as an instruction memory, is also operated at clock cycle CLK in this example. In addition, a data bus 116 has a data address bus or data address line 116A and a data bus or data line 116B. Data address bus or data address line 116A is connected to computer 100 via a data address terminal DA1 (data address 1) and to computer 101 via a data address terminal DA2 (data address 2). Also data bus or data line 116B is connected to computer 100 via a data terminal DO1 (data out 1) and to computer 101 via a data terminal DO2 (data out 2). Furthermore, data bus 116 has data bus line 116C, which is connected to computer 100 via a data terminal DI1 (data in 1) and to computer 101 via a data terminal DI2 (data in 2). In this data bus 116 having lines 116A, 116B, and 116C, a component 104, a data memory for example, a safe data memory in particular or the like, is connected in between. This component 104 is also supplied with clock cycle CLK.

Components 103 and 104 represent any components that are connected to the computers of the dual-core system via a data bus and/or instruction bus and are able to receive or output erroneous data and/or instructions corresponding to accesses via data and/or instructions of the dual-core system for read and/or write operations. Error identifier generators 105, 106, and 107, which generate an error identifier such as a parity bit, or another error code such as an error correction code (ECC), or the like, are provided for error prevention. For this purpose, appropriate error identifier checking devices 108 and 109 are also provided for checking the particular error identifier, i.e., the parity bit or another error code such as ECC, for example.

In the redundant design in the dual-core system, the data and/or instructions are compared in comparators 110 and 111 as depicted in FIG. 1. However, if there is a time offset, a clock pulse offset in particular, between computers 100 and 101, caused either by a non-synchronous dual-core system or, in the case of a synchronous dual-core system by synchronization errors, or as in this special example, by a time or clock pulse offset, here of 1.5 clock pulses in particular, provided for error detection, a computer, computer 100 in particular in this case, may write or read erroneous data and/or instructions in components, external components in particular such as memory 103 or 104 in particular in this case, but also with regard to other users or actuators or sensors during this time or clock pulse offset. It may thus erroneously perform a write access instead of an intended read access due to this clock pulse offset. These scenarios result, of course, in errors in the entire system, in particular without a clear possibility to display which data and/or instructions exactly have been erroneously changed, which also causes recovery problems.

In order to eliminate this problem, a delay unit 102, as shown, is connected into the lines of the data bus and/or into the instruction bus. For the sake of clarity, only the connection into the data bus is depicted. Of course, connection into the instruction bus is also possible and conceivable. This delay unit 102 delays the accesses, the memory accesses in particular in this case, so that a possible time offset or clock pulse offset is compensated, in particular in the case of an error detection, for example, via comparators 110 and 111, at least until the error signal is generated in the dual-core system, i.e., the error is detected in the dual-core system. Different variants may be implemented:

Delay of the write and read operations, delay of the write operations only, or, although not preferably, delay of the read operations. A delayed write operation may then be converted into a read operation via a change signal, the error signal in particular, in order to avoid erroneous writing.

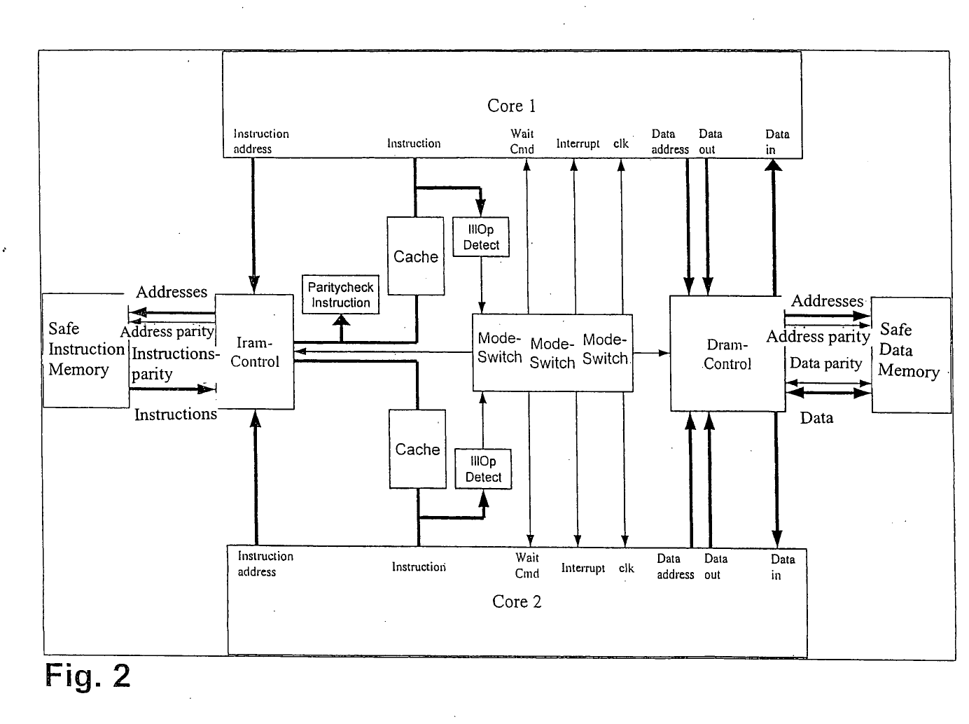

An exemplary implementation of the data distribution unit (DDU) which may be composed of a device for detecting the switchover intent (via IIIOPDetect), the mode switch unit, and the iram and dram control module is explained with reference to FIG. 2.

IllOpDetect: Switchover between the two modes is detected by the “switch detect” units. The unit is situated between the cache and the processor on the instruction bus and watches whether the IllOp instruction is loaded into the processor. If the instruction is detected, this event is communicated to the mode switch unit. The switch detect unit is provided separately for each processor. The switch detect unit does not have to have an error-tolerant design, since it is present in duplicate, i.e., redundantly. It is also conceivable to design this unit to be error-tolerant and thus without redundancy; however, the redundant design may be used.

ModeSwitch: Switchover between the two modes is triggered by the “switch detect” unit. If a switchover is to be performed from lock mode to split mode, both switch detect units detect the switchover, since both processors are processing the same program code in the lock mode. The switch detect unit of processor 1 detects these 1.5 clock pulses before the switch detect unit of processor 2. The mode switch unit stops processor 1 for two clock pulses with the aid of the wait signal. Processor 2 is also stopped 1.5 clock pulses later, but only for one-half of a clock pulse, thus being synchronized to the system clock. The status signal is subsequently switched to split for the other components and the two processors continue to operate. For the two processors to execute different tasks, they must diverge in the program code. This takes place via a read access to the processor ID directly after switching over into the split mode. The processor ID read is different for each of the two processors. If a comparison is made with a reference processor ID, the corresponding processor may be brought to another program point using a conditional jump instruction. When switching over from split mode to lock mode, this is noticed by a processor, i.e., by one before the other. This processor will execute program code containing the switchover instruction. This is now registered by the switch detect unit, which informs the mode switch unit accordingly. The mode switch unit stops the corresponding processor and informs the second one of the synchronization intent via an interrupt. The second processor receives an interrupt and may now execute a software routine to terminate its task. It then jumps to the program point where the switchover instruction is located. Its switch detect unit now also signals the intent to change modes to the mode switch unit. At the next rising system clock edge, the wait signal is deactivated for processor 1 and, 1.5 clock pulses later, for processor 2. Now both processors work synchronously with a clock pulse offset of 1.5 clock pulses.

If the system is in lock mode, both switch detect units must inform the mode switch unit that they intend to switch to the split mode. If the switchover intent is only communicated by one unit, the error is detected by the comparator units, since these continue to receive data from one of the two processors, and this data is different from that of the stopped processor.

If both processors are in the split mode and one switches back to the lock mode, this may be detected by an external watchdog. In the event of a trigger signal for each processor, the watchdog notices that the waiting processor is no longer sending messages. If there is only one watchdog signal for the processor system, the watchdog may only be triggered in the lock mode. The watchdog would thus detect that no mode switchover has taken place. The mode signal is in the form of a dual-rail signal, where 10 stands for the lock mode and 01 for the split mode. 00 and 11 indicate errors.

IramControl: Access to the instruction memory of both processors is controlled via the IRAM control, which must have a reliable design, since it is a single point of failure. It has two state machines for each processor: one synchronous machine, iramlclkreset, and one asynchronous machine, readiraml. In the safety-critical mode, the state machines of the two processors monitor one another, and in the performance mode they operate separately.

Reloading the two caches of the processors is controlled by two state machines, one synchronous state machine iramclkreset and one asynchronous state machine readiram. These two state machines also distribute the memory accesses in the split mode. Processor 1 has the higher priority. After an access by processor 1 to the main memory, if both processors now intend to access the main memory, processor 2 receives the memory access permission. These two state machines are implemented for each processor. In the lock mode, the output signals of the state machines are compared in order to detect the occurrence of any error.

The data for updating cache 2 in the lock mode is delayed by 1.5 clock pulses in the IRAM control unit.

In bit 5 in register 0 of SysControl, the identity of the core is encoded. For core 1 the bit is 0 and in the case of core 2 it is high. This register is mirrored in the memory area having the address 65528.

In the event of a memory access by core 2, a check is first made to determine in what mode the core is operating. If it is in the lock mode, its memory access is suppressed. This signal is in the form of a common rail signal, since it is critical with regard to safety.

The program counter of processor 1 is delayed by 1.5 clock pulses to enable a comparison with the program counter of processor 2 in the lock mode.

In the split mode, the caches of both processors may be reloaded separately. If a switchover into the lock mode is performed, the two caches are not coherent with respect to one another. This may cause the two processors to diverge and the comparators to thus signal an error. To avoid this, a flag table is constructed in the IRAM control, where it is noted whether a cache line has been written in the lock mode or in the split mode. When the cache is reloaded in the lock mode, the entry corresponding to the cache line is set at 0, and when it is reloaded in the split mode or when the cache line of a single cache is updated, it is set at 1. If the processor now accesses the memory in the lock mode, a check is performed of whether this cache line has been updated in the lock mode, i.e., whether it is identical in the two caches. In the split mode, the processor may always access the cache line, regardless of the status of the Flag_Vector. This table must be present only once, since in the event of an error, the two processors diverge and thus this error is reliably detected by the comparators. Since the access times to the central table are relatively long, this table may also be copied to each cache.

DramControl: The parity is formed in this component for the address, data, and memory control signals of each processor.

There is a process for both processors for locking the memory. This process does not have to have a fail-safe design, since in the lock mode erroneous memory accesses are detected by the comparators and in the split mode no safety-relevant applications are executed. A check is performed here of whether the processor intends to lock the memory for the other processor. The data memory is locked via an access to the memory address $FBFF$=64511. This signal must be applied for one clock pulse even if a wait instruction is being applied to the processor at the time of the call. The state machine for managing the data memory access has two main states:
processor status lock: Both processors operate in the lock mode. This means that the data memory locking function is not needed. Processor 1 coordinates the memory accesses.
processor status split: A data memory access conflict resolution is now necessary, and memory lock must be able to occur.

The split mode state is in turn subdivided into seven states which resolve the access conflicts and are able to lock the data memory for the other processor. When both processors intend to access the memory at the same time, the order of execution represents the priorities at the same time.
Core1\_Lock: Processor 1 has locked the data memory. If processor 2 intends to access the memory in this state, it is stopped by a wait signal until processor 1 releases the data memory again.\
Core2\_Lock: This is the same state as the previous one, except that now processor 2 has locked the data memory and processor 1 is stopped for data memory operations.
lock1_wait: The data memory was locked by processor 2 as processor 1 also intended to reserve it for itself. Processor 1 is thus pre-marked for the next memory lock.
nex: The same for processor 2. The data memory was locked by processor 1 during the locking attempt. The memory is pre-reserved for processor 2. In the event of normal memory access without locking, processor 2 may have access before processor 1 if processor 1 was up previously.
Memory access by processor 1: The memory is not locked in this case. Processor 1 is allowed to access the data memory. If it intends to lock it, it may do so in this state.
Memory access by processor 2: Processor 1 did not intend to access the memory in the same clock pulse; therefore, the memory is free for processor 2.
No processor intends to access the data memory.

As mentioned previously, the DDU has the switchover intent detector (IllOPDetect), the mode switch unit, and the Iram and Dram control.

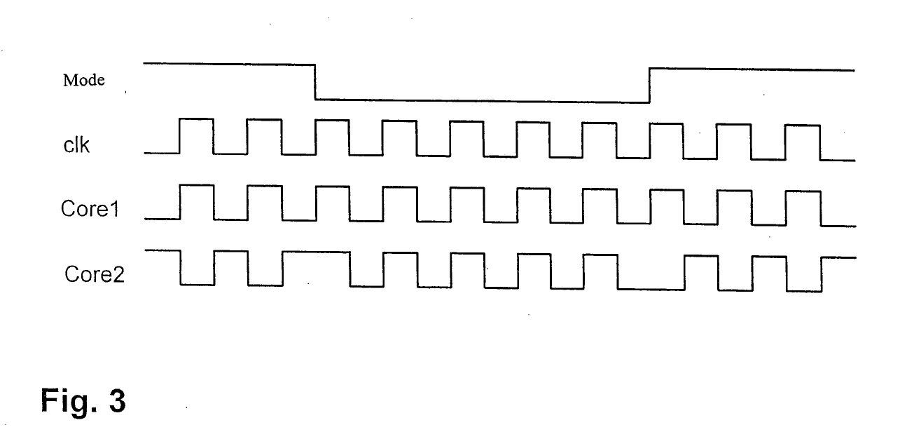

FIG. 3 shows the clock pulse switchover using an example, so that a clock pulse switchover takes place from one mode into another mode. Both modes, clock CLK, and the clock pulses of both processors are shown.

The two processors operate in a clock pulse offset in one mode. They may be offset with respect to one another by entire clock pulses or by a part of a clock pulse. In another variant, different clock frequencies are used in the two modes. In the safety-critical mode, a lower clock frequency may be used than in the performance mode to suppress interference. The two variants may also be combined.

The object recited in the preamble is also achieved by the special implementation shown.

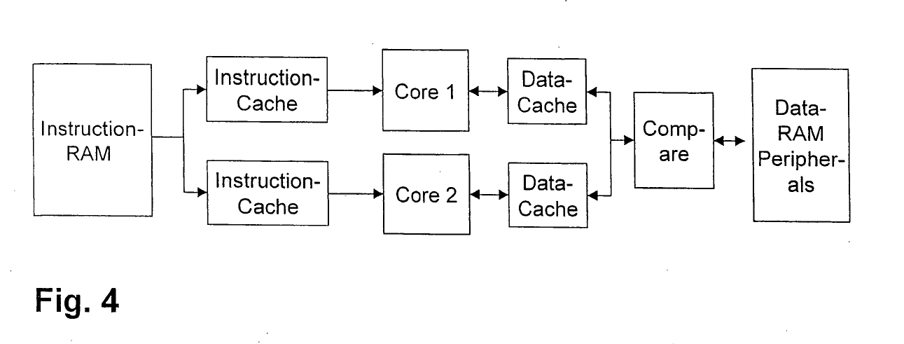

In the implementations of dual-core systems in particular, a cache is provided for each processor, as schematically depicted again in FIG. 4. One cache is usually insufficient, since this cache must be spatially situated between the two processors. Due to the long propagation time between the cache and the two processors, the two processors may therefore only operate at a limited clock frequency.

Caches are also used as fast buffer memories, so the processor does not need to retrieve the data from the slow main memory. To make this possible, this access time must be taken into account in the implementation. The access time is composed of the actual access time for retrieving the data from the cache and the time for relaying the data to the processor. If the cache is spatially situated far away from the processor, the transmission of data takes too long and the processor is unable to operate at its full clock frequency. Due to this timing problem, in dual-core systems a separate cache is usually provided for each processor.

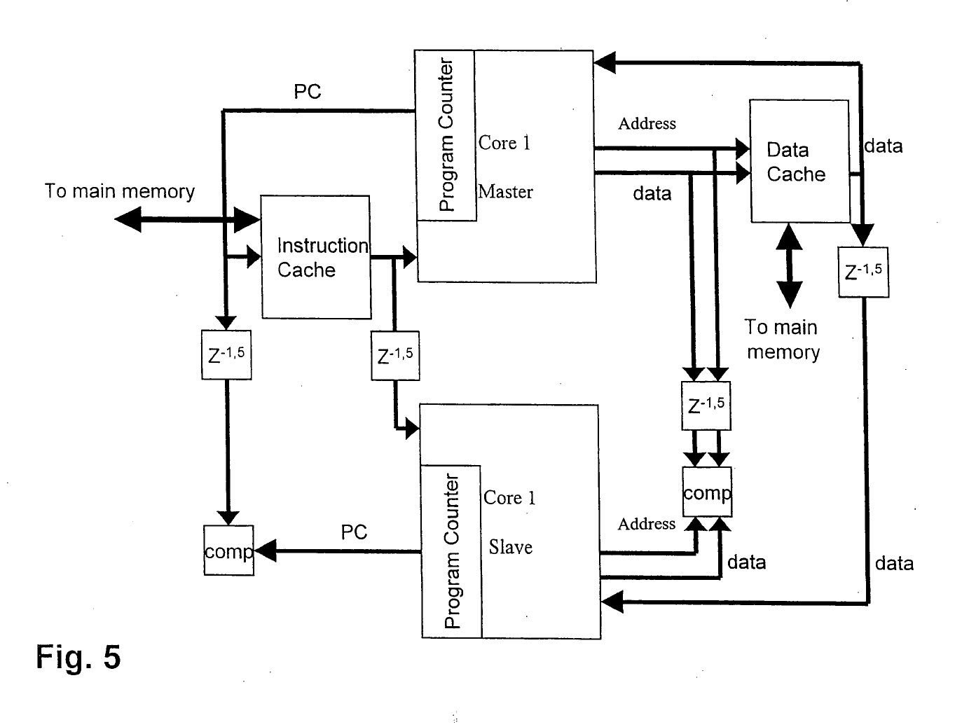

When these two processors are operated at a clock pulse offset, the second cache for the slave processor is no longer needed when using the method proposed in FIG. 5.

A cache requires plenty of chip area and plenty of current. As a result, a large amount of heat is produced, which must be dissipated. If one cache may be omitted, a dual-core system may be implemented at a substantially lower cost.

In the dual-core system presented here, one processor is the master and the other processor is the slave. The master processes the data first and thus also activates the peripheral components such as memory, cache, DMA controller, etc. The slave processes the same data with a clock pulse offset of 1.5 clock pulses in this case, for example. This also means that it receives the data from the shared memory and from the external components which are also delayed by the same time period. The output data of both processors such as memory address, data, etc. are compared. To be able to compare the data, the results of the master must also be buffered for 1.5 clock pulses. Such an exemplary system is illustrated on the bottom.

To be able to use only one cache for both processors according to FIG. 5, the instruction cache and the data cache are situated directly on the master as in the case of a single processor. Therefore, the master is not affected by any drop in performance due to the propagation times between cache and processor. Since the slave processes the data 1.5 clock pulses later, this time may be used for conveying the data to the second processor which is now spatially farther removed from the cache.

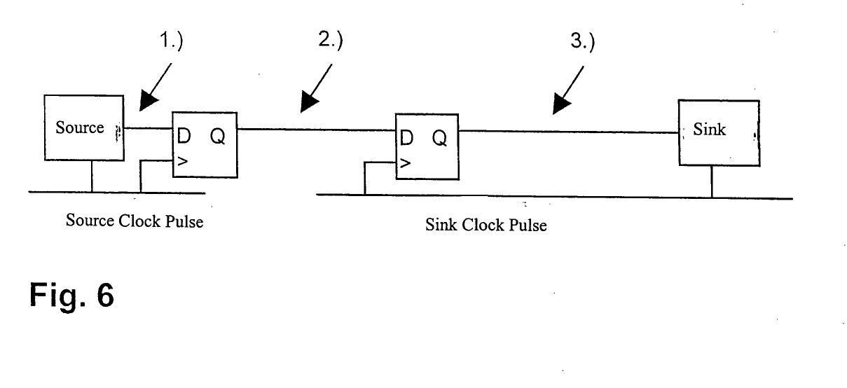

In the case of an exemplary clock pulse offset of 1.5 clock pulses, two flip-flops may be used for this purpose, as shown in FIG. 6. The first one is controlled using the master's clock pulse, and the second one using the slave's clock pulse. The first flip-flop is positioned directly at the output of the source. The second one, depending on the distance the signal is able to travel during the interval between the two clock pulses, is positioned closer to the slave. For a clock pulse offset of 1.5 clock pulses, this corresponds to the propagation time of one-half of a clock pulse, and for a clock pulse offset of 2 clock pulses to the propagation time of one clock pulse. The second flip-flop then receives the signal. The distance the signal is able to travel during an entire clock pulse may now be bridged again. In the figure this is represented by 1.) showing the location close to the sink; 2.) corresponds to the distance that can be traveled during the clock pulse difference, and 3.) is the distance that can be traveled during one clock pulse downstream from the second flip-flop.

1-23. (canceled)

24. A method for delaying an access to at least one of data and an instruction of a multiprocessor system having a first and a second processor, with which a memory unit is associated, the method comprising:
operating the second processor with a clock pulse offset, wherein the system is arranged so that the first processor accesses the memory unit and the second processor receives the data with the clock pulse offset.

25. The method of claim 24, wherein the clock pulse offset is used by a delay element for bridging the propagation time of the access to at least one of the data and the instruction from the memory unit to the second processor.

26. The method of claim 24, wherein the clock pulse offset is used for transmitting comparison data of the first processor to the second processor.

27. The method of claim 24, wherein a write operation and a read operation are delayed as accesses.

28. The method of claim 24, wherein only write operations are delayed as accesses.

29. The method of claim 24, wherein only read operations are delayed as accesses.

30. The method of claim 24, wherein the clock pulse offset is predefined as multiples of 0.5.

31. The method of claim 24, wherein the clock pulse offset is predefined as an integer.

32. The method of claim 24, wherein the clock pulse offset is predefined as 1.5 clock pulses.

33. A device for delaying access to at least one of data and an instruction of a multiprocessor system having a first and a second processor, with which a memory unit is associated, the second processor operating with a clock pulse offset, comprising:
an arrangement to provide that the first processor accesses the memory unit and that the second processor receives at least one of the data and the instruction with a clock pulse offset.

34. The device of claim 33, wherein the memory unit includes a cache.

35. The device of claim 33, wherein the memory unit is addressed by at least one processor and the memory unit is directly connected to the processor which addresses it.

36. The device of claim 33, wherein the arrangement includes a delay element, which uses the clock pulse offset for bridging a propagation time of the at least one of the data and the instruction from the memory unit to the second processor.

37. The device of claim 33, wherein the arrangement includes a comparing arrangement to compare the at least one of the data and the instruction.

38. The device of claim 37, wherein the comparing arrangement is spatially situated near a following processor.

39. The device of claim 37, wherein the clock pulse offset is used for transmitting comparison data of the first processor to the second processor.

40. The device of claim 33, wherein the write operations and the read operations are delayed as accesses.

41. The device of claim 33, wherein only the write operations are delayed as accesses.

42. The device of claim 33, wherein only the read operations are delayed as accesses.

43. The device of claim 33, wherein the clock pulse offset is predefined as multiples of 0.5.

44. The device of claim 33, wherein the clock pulse offset is predefined as an integer.

45. The device of claim 33, wherein the clock pulse offset is predefined as 1.5 clock pulses.

46. A multiprocessor system comprising:
a device for delaying access to at least one of data and an instruction of a multiprocessor system having a first and a second processor, with which a memory unit is associated, the second processor operating with a clock pulse offset, including:
an arrangement to provide that the first processor accesses the memory unit and that the second processor receives at least one of the data and the instruction with a clock pulse offset.
